(19) United States
(12) Patent Application Publication
(10) Pub. No.: US 2012/0163292 A1
(43) Pub. Date: Jun. 28, 2012

(54) Frame Header in Wireless Communication System

(75) Inventors: Jarkko KNECKT, Espoo (FI); Mika KASSLIN, Espoo (FI)

(73) Assignee: Nokia Corporation

(21) Appl. No.: 12/977,735

(22) Filed: Dec. 23, 2010

(51) Int. Cl. H04W 4/00

(52) U.S. Cl. 370/328

(57) ABSTRACT

A method, apparatus, and computer program for providing a physical layer convergence protocol header for the frame, wherein the physical layer convergence protocol (PLCP) header is arranged to comprise information identifying a subset of group-addressed frames to which the frame belongs. The identification of the subset enables a receiver to determine from the PLCP header whether or not to process the frame.

### FIELD

The invention relates to the field of wireless telecommunications and, particularly, to signaling methods used in a wireless telecommunication system.

### BACKGROUND

Wireless Local Area Network (WLAN) has undergone vast development in order to increase throughput. Task groups such as 802.11b, 802.11a, 802.11g and 802.11n have demonstrated continuous improvement of the WLAN radio throughput. 802.11ac is another task group that is developing the WLAN radios that operate at a frequency spectrum below 6 GHz and especially at 5 GHz. There exist other task groups within the IEEE 802.11 standardization.

Channelization rules for 802.11ac radios are currently under development. The rules define the frequency channels available for 802.11ac transmitters. The rules are based on a scheme of a primary channel and secondary channels. The scheme follows a principle where each network or basic service set (BSS) has a primary channel and zero or more secondary channels. The primary channel is used for channel contention, and transmission opportunity (TXOP) is gained based on carrier sensing on the primary channel. A physical layer protocol and physical layer signaling methods are also under development.

### BRIEF DESCRIPTION

According to an aspect of the present invention, there is provided a method comprising: receiving, in a wireless communication apparatus, a physical layer convergence protocol header of a frame; determining from header information comprised in the physical layer convergence protocol header a subset of group-addressed frames to which the frame belongs; determining whether or not the wireless communication apparatus is configured to process the determined subset of the frame; and upon determining that the wireless communication apparatus is not configured to process the subset of the frame, causing the wireless communication apparatus to enter a power-save mode.

In an embodiment, one subset indicated by the header information comprised in the physical layer convergence protocol header defines that the frame is a data frame addressed to a plurality of recipients, wherein the physical layer convergence protocol header comprises an identifier defining a group of recipients for the frame, wherein the identifier is at least one of a group address and a multicast stream identifier, and the method further comprises: determining that the received frame belongs to the subset of the data frame addressed to a plurality of recipients; determining whether or not the wireless communication apparatus is configured to process the subset; and upon determining that the wireless communication apparatus is not configured to process the subset, causing the wireless communication apparatus to enter the power-save mode and, otherwise, configuring the wireless communication apparatus to process a payload portion of the frame.

In an embodiment, the header information comprised in the physical layer convergence protocol header comprises a group identifier field as an information element, wherein the group identifier defines whether the frame is addressed to a single recipient or to a group address, and wherein the header information further comprises another field that defines a subset of group-addressed frames when the group identifier field defines the frame being addressed to the group address, and the other field has another function when the group identifier field defines the frame being addressed to the single recipient.

In an embodiment, the header information comprised in the physical layer convergence protocol header comprises an information element defining a maximum number of spatial streams in a single-user transmission, a recipient address when the frame is addressed to a single recipient, and the subset of group-addressed frames when the frame is addressed to a group address.

In an embodiment, the header information comprised in the physical layer convergence protocol header comprises an information element indicating, as subsets of group-addressed frames, whether or not an acknowledgment message is allocated to be transmitted after the frame, the method further comprising determining, from the information element indicating whether or not the acknowledgment message is allocated to be transmitted after the frame, whether or not to a determined time interval after the frame is reserved for the acknowledgment message.

In an embodiment, one subset indicated by the header information comprised in the physical layer convergence protocol header defines that the frame is a management frame addressed to a plurality of recipients, wherein the physical layer convergence protocol header comprises an identifier defining a group of recipients for the frame, and the method further comprises: determining that the wireless communication apparatus is configured to process only management frames; determining from the header information comprised in the physical layer convergence protocol header whether or not the frame is a management frame; and discarding the frame, if the frame is not determined to be the management frame, while processing the frame, if the frame is determined to be the management frame.

According to an aspect, there is provided a method comprising: initiating, in a wireless communication apparatus, transmission of a frame; generating a physical layer convergence protocol header for the frame, wherein the physical layer convergence protocol header is arranged to comprise information identifying a subset of group-addressed frames to which the frame belongs; and causing the wireless communication apparatus to transmit the frame comprising the physical layer convergence protocol header.

In an embodiment, the method further comprises including in the physical layer convergence protocol header an information element that defines a subset of the frame being a management frame addressed to a group address.

In an embodiment, the method further comprises including in the physical layer convergence protocol header an information element that defines a subset of the frame being a group-addressed data frame that does not belong to any flexible multicast stream assigned with a flexible multicast stream identifier.

In an embodiment, the method further comprises including in a group identifier field of the physical layer convergence protocol header an information element having a first value for defining that the frame is addressed to a single recipient and a second value for defining that the frame is addressed to a group address, and wherein the header information further comprises another field that defines a subset of group-addressed frames when the group identifier field defines the frame being addressed to the group address, and the other field has another function when the group identifier field defines the frame being addressed to the single recipient.

According to an aspect, there is provided an apparatus comprising at least one processor; and at least one memory comprising a computer program code, wherein the at least one memory and the computer program code are configured, with the at least one processor, to cause the apparatus to: receive a physical layer convergence protocol header of a frame; determine from header information comprised in the physical layer convergence protocol header a subset of group-addressed frames to which the frame belongs; determine whether or not the apparatus is configured to process the determined subset of the frame; and upon determining that the apparatus is not configured to process the subset of the frame, causing the apparatus to enter a power-save mode.

In an embodiment, one subset indicated by the header information comprised in the physical layer convergence protocol header defines that the frame is a data frame addressed to a plurality of recipients, wherein the physical layer convergence protocol header comprises an identifier defining a group of recipients for the frame, wherein the identifier is at least one of a group address and a multicast stream identifier, and wherein the at least one memory and the computer program code are configured, with the at least one processor, to cause the apparatus to: determine that the received frame belongs to the subset of the data frame addressed to a plurality of recipients; determine whether or not the apparatus is configured to process the subset; and upon determining that the apparatus is not configured to process the subset, causing the apparatus to enter the power-save mode and, otherwise, configuring the apparatus to process a payload portion of the frame.

In an embodiment, the header information comprised in the physical layer convergence protocol header comprises a group identifier field as an information element, wherein the group identifier defines whether the frame is addressed to a single recipient or to a group address, wherein the header information further comprises another field that defines a subset of group-addressed frames when the group identifier field defines the frame being addressed to the group address, and the other field has another function when the group identifier field defines the frame being addressed to the single recipient.

In an embodiment, the header information comprised in the physical layer convergence protocol header comprises an information element defining a maximum number of spatial streams in a single-user transmission, a recipient address when the frame is addressed to a single recipient, and the subset of group-addressed frames when the frame is addressed to a group address.

In an embodiment, the header information comprised in the physical layer convergence protocol header comprises an information element indicating, as subsets of group-addressed frames, whether or not an acknowledgment message is allocated to be transmitted after the frame, and wherein the at least one memory and the computer program code are configured, with the at least one processor, to cause the apparatus to determine, from the information element indicating whether or not the acknowledgment message is allocated to be transmitted after the frame, whether or not to a determined time interval after the frame is reserved for the acknowledgment message.

In an embodiment, one subset indicated by the header information comprised in the physical layer convergence protocol header defines that the frame is a management frame addressed to a plurality of recipients, wherein the physical layer convergence protocol header comprises an identifier defining a group of recipients for the frame, and wherein the at least one memory and the computer program code are configured, with the at least one processor, to cause the apparatus to: determine that the apparatus is configured to process management frames; determine from the header information comprised in the physical layer convergence protocol header whether or not the frame is a management frame; and discard the frame, if the frame is not determined to be the management frame, while processing the frame, if the frame is determined to be the management frame.

According to an aspect, there is provided an apparatus, comprising at least one processor; and at least one memory comprising a computer program code, wherein the at least one memory and the computer program code are configured, with the at least one processor, to cause the apparatus to: initiate transmission of a frame; generate a physical layer convergence protocol header for the frame, wherein the physical layer convergence protocol header is arranged to comprise information identifying a subset of group-addressed frames to which the frame belongs; and cause the apparatus to transmit the frame comprising the physical layer convergence protocol header.

In an embodiment, the at least one memory and the computer program code are configured, with the at least one processor, to cause the apparatus to include in the physical layer convergence protocol header an information element that defines a subset of the frame being a management frame addressed to a group address.

In an embodiment, the at least one memory and the computer program code are configured, with the at least one processor, to cause the apparatus to include in the physical layer convergence protocol header an information element that defines a subset of the frame being a group-addressed data frame that does not belong to any flexible multicast stream assigned with a flexible multicast stream identifier.

In an embodiment, the at least one memory and the computer program code are configured, with the at least one processor, to cause the apparatus to include in a group identifier field of the physical layer convergence protocol header an information element having a first value for defining that the frame is addressed to a single recipient and a second value for defining that the frame is addressed to a group address, and wherein the header information further comprises another field that defines a subset of group-addressed frames when the group identifier field defines the frame being addressed to the group address, and the other field has another function when the group identifier field defines the frame being addressed to the single recipient.

In an embodiment, the apparatus further comprises radio interface components providing the apparatus with radio communication capability in a wireless communication network.

According to an aspect, there is provided an apparatus comprising means for carrying out any one of the above-described methods. According to another aspect, there is provided a computer program product embodied on a distribution medium readable by a computer and comprising program instructions which, when loaded into an apparatus, execute any one of the above-described methods. According to another aspect, there is provided a (transitory or non-transitory) computer-readable distribution medium storing such a computer program product.

### LIST OF DRAWINGS

Embodiments of the present invention are described below, by way of example only, with reference to the accompanying drawings, in which

FIG. 1A illustrates communication network to which some embodiments of the invention may be applied;

FIG. 1B illustrates a channel allocation principle according to an embodiment;

FIGS. 2 and 3 illustrate flow diagrams of transmission and reception processes according to an embodiment of the invention, respectively;

FIG. 4 illustrates a header of a frame;

FIG. 5 illustrates a transmitted frame followed by an acknowledgment period;

FIG. 6 illustrates concatenated acknowledgment periods; and

FIG. 7 illustrates a block diagram of an apparatus according to an embodiment of the invention.

### DESCRIPTION OF EMBODIMENTS

The following embodiments are exemplary. Although the specification may refer to “an”, “one”, or “some” embodiments) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

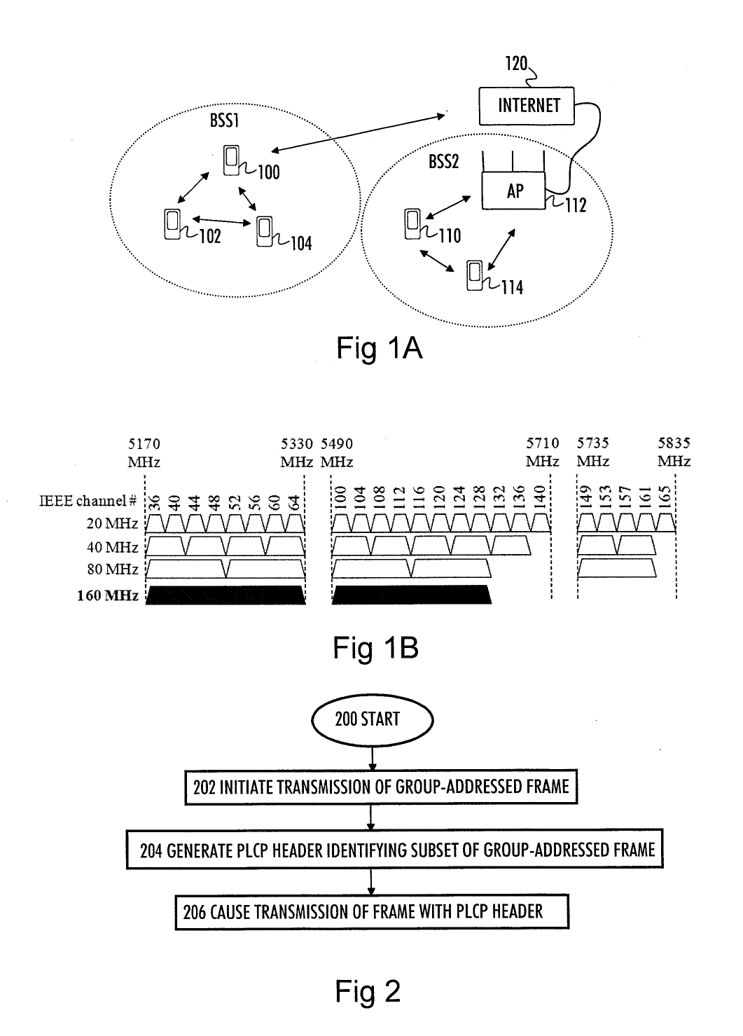

A general architecture of a wireless telecommunication system to which embodiments of the invention may be applied is illustrated in FIG. 1A. FIG. 1A illustrates two groups of wireless communication devices forming two basic service sets, i.e. groups of wireless communication devices comprising an access point (AP) 100, 112 and terminal stations (STA) 102, 104, 110, 114 communicating with the access points 100, 112 of their respective groups. A basic service set (BSS) is a basic building block of an IEEE 802.11 wireless local area network (WLAN). The most common BSS type is an infrastructure BSS that includes a single AP together with all associated STAs. The AP may be a fixed AP as AP 112, or it may be a mobile AP as AP 100. The APs 100, 112 may also provide access to other networks, e.g. the Internet 120. In another embodiment, at least one of the BSSs is an independent BSS (IBSS) or a mesh BSS (MBSS) without a dedicated AP, and in such embodiments the communication device 100 may be a non-access-point terminal station. While embodiments of the invention are described in the context of the above-described topologies of IEEE 802.11 and, particularly, IEEE 802.11ac, it should be appreciated that other embodiments of the invention are applicable to networks based on other specifications, e.g. other versions of the IEEE 802.11, WiMAX (Worldwide Interoperability for Microwave Access), UMTS LTE (Long-term Evolution for Universal Mobile Telecommunication System), and other networks.

The 802.11n specifies a data transmission mode that includes 20 MHz wide primary channel and 20 MHz wide auxiliary channels. The primary channel is used in all data transmissions, and with clients supporting only the 20 MHz mode. A further definition in 802.11n is that the primary and auxiliary channels are adjacent. The 802.11n specification also defines a mode in which a STA can have only one auxiliary channel which results in a maximum bandwidth of 40 MHz. IEEE 802.11ac task group extends such an operation model to provide for wider bandwidths by increasing the number of auxiliary channels from 1 up to 7, thus resulting in bandwidths of 20 MHz, 40 MHz, 80 MHz, and 160 MHz. FIG. 1B illustrates an exemplary channel structure for 20 MHz, 40 MHz, 80 MHz, and 160 MHz channels. In this example, a 40 MHz transmission band is formed by two contiguous 20 MHz bands, and an 80 MHz transmission band is formed by two contiguous 40 MHz bands. However, a 160 MHz band may be formed by two contiguous or non-contiguous 80 MHz bands. As the specification is currently under constant development, this channel utilization principle should be construed as providing merely an example, and the embodiments of the invention are applicable to various channel structures.

As mentioned above, the transmission band of a BSS contains the primary channel and zero or more auxiliary channels. The auxiliary channels may be denoted by secondary, tertiary, quaternary, etc. channels in the order that they may be used in addition to the primary channel, for example. The primary channel may be used for channel contention, and a transmission opportunity (TXOP) is gained based on carrier sensing on the primary channel. Every STA may have a time duration (defined by a backoff factor), and if the STA detects that the primary channel has been free for the time duration, it gains the TXOP and starts transmission. If another STA gains the TXOP before that, the channel sensing is suspended, and the STA proceeds with the channel sensing after the TXOP of the other STA has ended. The time duration (the backoff factor) may not be reset at this stage, and the time duration that already lapsed before the suspension is also counted, which means that the STA now has a higher probability of gaining the TXOP. A secondary channel may be used in the transmission if it has been free for a determined time period (may be the same or different time period than that used for gaining the TXOP) just before TXOP start time in order for the contending STA to take the secondary channel in use. The same principle may apply to other auxiliary channels. When the TXOP begins, the STA controls the utilization of the primary channel (and other channels of the TXOP). The STA may, for example carry out data transmission to one or a plurality of receiving STAB during the TXOP. The transmission may be transmitted to an individual address, i.e. to a single receiver, in which case the receiver may be defined in a physical layer convergence protocol (PLCP) header and/or a medium access control (MAC) header of the individually addressed transmission. Yet alternatively, the transmission may be targeted to a multicast or to a broadcast address in which case the transmission may be targeted to receivers that are configured to receive the multicast transmission or to no predefined receivers, and the broadcast nature may be defined in the header of the data transmission. At least some of the header information may be received by all communication apparatuses that monitor at least one of the channels on which the transmission is carried out.

An embodiment of the present invention configures a wireless communication apparatus receiving a PLCP header at a beginning of a frame to determine from header information to which subset of group-addressed frames the received frame belongs. This enables the wireless communication apparatus to determine from the PLCP header whether it should receive and process a payload of the frame and, when the payload should not be processed, the wireless communication apparatus may discard the frame and save processing and power resources. The configuration may be carried out in the wireless communication apparatus, e.g. by a controller or a processor comprised in the wireless communication apparatus. FIG. 2 illustrates a flow diagram of a process for providing information in the PLCP header that enables a receiver to determine whether to receive a frame comprising the PLCP header. The process starts in block 200. The process is carried out in a wireless communication apparatus carrying out data transmission over a radio interface in frames. In block 202, the wireless communication apparatus initiates transmission of a frame. This may comprise gaining a TXOP for a determined time-frequency resources, or there may be another trigger that initiates generation of a frame comprising the PLCP header for transmission. The frame may be a data frame, e.g. a protocol packet data unit (PPDU) or a service data unit (SDU), or it may be a management frame, e.g. a Medium Access Control (MAC) Management Payload Data Unit (MMPDU). The management frame may be comprised in a beacon signal transmitted by the wireless communication apparatus. The frame may also be another type of control frame.

In block 204, the wireless communication apparatus generates the PLCP header for the frame. The wireless communication apparatus include in the PLCP header at least one information element that identifies a subset of group-addressed frames to which the frame belongs. By definition, a destination address of a group-addressed frame may be a group address.

In block 206, the wireless communication apparatus transmits the frame comprising the PLCP header comprising the above-mentioned at least one information element that identifies the subset of group-addressed frames to which the frame belongs.

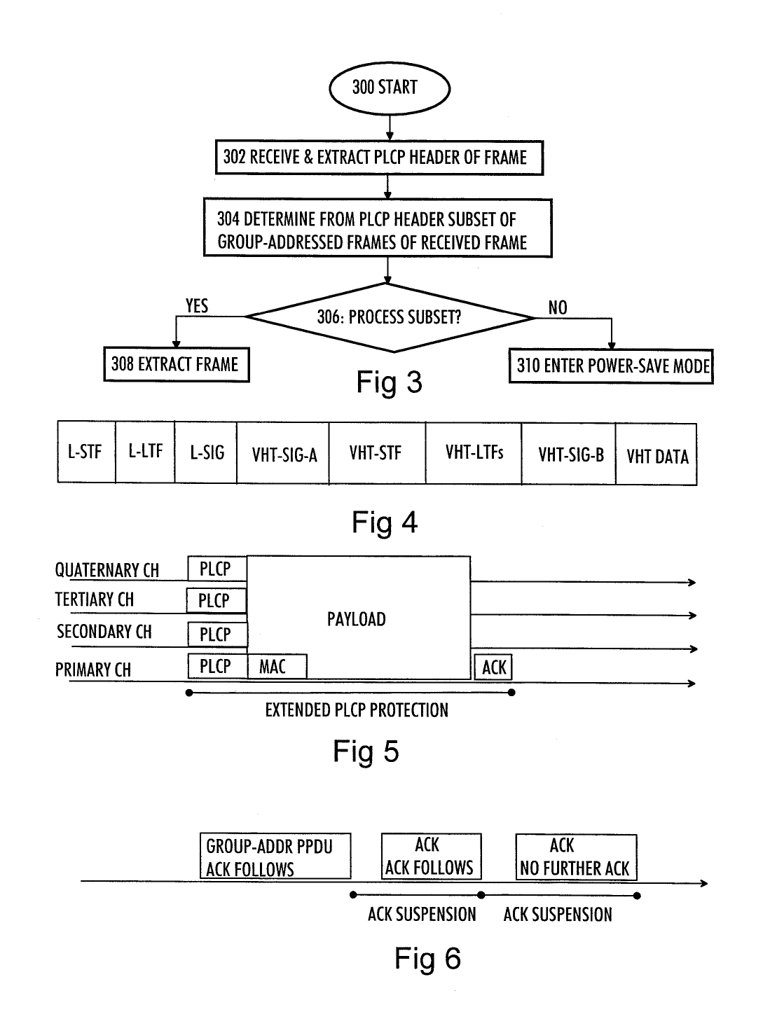

FIG. 3 illustrates operation when receiving the frame generated in the process of FIG. 2. The process of FIG. 3 is carried out in another wireless communication apparatus carrying out data reception over the radio interface. The process starts in block 300. In block 302, the wireless communication apparatus receives the above-mentioned PLCP header of the frame. In block 304, the wireless communication apparatus determines from header information comprised in the PLCP header a subset of group-addressed frames to which the frame belongs. In block 306, the wireless communication apparatus determines whether or not the wireless communication apparatus is configured to process the subset to which the received frame is determined to belong in block 304. Upon determining that the wireless communication apparatus is not configured to process the subset of group-addressed frames associated with the frame and by deciding the length of the group addressed frames transmission in block 306, the process proceeds to block 310 where the wireless communication apparatus is configured to enter a power-save mode where the wireless communication apparatus avoids reception for the duration of the group-addressed frame transmission. On the other hand, upon determining that the wireless communication apparatus is configured to process the subset of group-addressed frames associated with the frame in block 306, the process proceeds to block 308 where the wireless communication apparatus is configured to extract a payload portion of the frame.

Some embodiments of the invention include in the PLCP information that enables a receiver to determine whether or not to process the frame. Other embodiments configure the receiver to determine on the basis of the PLCP header whether or not to process the frame. The PLCP header is transmitted at the beginning in the header of the frame and, thus, the determination whether or not to process the frame may be made quickly and by using only the information contained in the PLCP header. As indicated in the Table 1, the VHT-Sig A2 includes CRC (cyclic redundancy check) checksum and the receiver may detect the correct reception of the PLCP headers by calculating CRC check sum from PLCP header and comparing the calculated and received CRCs. This enables the receiver to discard the frame on the basis of the PLCP header, and processing resources may be saved and power consumption may be reduced. In contrast, prior art solutions require the reception of a MAC header, payload and Frame Control Sequence (FCS) which is CRC checksum of the MAC header and the payload. The recipient calculates the CRC checksum from MAC header and payload and compares the calculated CRC and received FCS to detect has it received the transmission correctly. As a consequence, prior art solutions require processing and reception of the whole transmitted frame. The prior art solution requires more than mere PLCP header before it may be decided whether or not to extract the payload portion of the frame, while some embodiments of the present invention are able to decide exclusively on the basis of the PLCP header whether or not to extract the payload portion of the frame.

With respect to the information element(s) that are used to define the subset of group-addressed frames, the information element(s), may be comprised in a PLCP header comprised in a very high throughput (VHT) PPDU according to IEEE 802.11ac. FIG. 4 illustrates an embodiment of the PLCP header comprised in such a VHT PPDU. The PPDU comprises VHT data and a plurality of control fields: Legacy Short Training Field (L-STF), Legacy Long Training Field (L-LTF), Legacy Long Signal Field (L-SIG), VHT Signal Field A (VHT-SIG-A), VHT Short Training Field (VHT-STF), VHT Long Training Fields (VHT-STFs), and VHT Signal Field B (VHT-SIG-B). The PLCP header may be transmitted as a separate header on every channel used for transmitting the frame and, therefore, the PLCP header may be received by any wireless communication apparatuses scanning for transmissions on any channel used for transmitting the frame.

The information element(s) from which the subset of the group-addressed frames may be determined, may be comprised in the VHT-SIG-A field, and it may be determined from a group identifier (Group ID) field and/or N_{STS} (Number of Spatial Streams) of Table 1 below.

TABLE 1

| | | | |
|---|---|---|---|
| Bit | | Bit | |
| Index | Field | allocation | Description |

VHT-SIG-A1

| | | | |
|---|---|---|---|
| 0-1 | BW | 2 | Set to 0 for 20 MHz, 1 for 40 MHz, 2 for 80 MHz, 3 for 160 MHz |
| | | | and 80 + 80 MHz mode |
| 2 | Reserved | 1 | Reserved for possible expansion of BW field. Set to 1. |
| 3 | STBC | 1 | Set to 1 if all streams use STBC, otherwise set to 0. When |
| | | | STBC bit is 1, an odd number of space time streams per user |
| | | | is not allowed. |
| 4-9 | Group ID | 6 | A value of all ones indicates [10/0382r2]: |
| | [10/0582r1] | | A single user transmission |
| | | | A transmission where the group membership to a |
| | | | MU-MIMO group has not yet been established |
| | | | A single-user (SU) MIMO transmission that needs to |
| | | | bypass a group (e.g. broadcast) |
| | | | Another value, e.g. [1, 1, 1, 1, 1, 0], indicates a group-addressed |
| | | | frame, |
| 10-21 | N_{STS} | 12 | For MU: 3 bits/user with maximum of 4 users |
| | [10/0582r1] | | Set to 0 for 0 space time streams |
| | | | Set to 1 for 1 space time stream |
| | | | Set to 2 for 2 space time streams |
| | | | Set to 3 for 3 space time streams |
| | | | Set to 4 for 4 space time streams |
| | | | Otherwise: first 3 bits contain stream allocation, set to 0 for 1 |
| | | | space time stream, set to 1 for 2 space time streams, etc. |
| | | | up to 8 streams. Remaining 9 bits depend on GroupID |
| | | | field value, as set out below. |
| 22-23 | Reserved | 2 | All ones |
| | Total | 24 | |

VHT-SIG-A2

| | | | |
|---|---|---|---|
| 0-1 | Short GI | 2 | Set B0 to 0 for Long GI, set to 1 for Short GI |
| | | | Set B1 to 1 when Short GI and N_{sym} %10 == 9 |
| 2-3 | Coding | 2 | Set B2 to 0 for BCC, set to 1 for LDPC |
| | | | B3 purpose is under discussion |
| 4-7 | MCS | 4 | For SU/Broadcast/Multicast: MCS index |
| | | | For MU: Reserved, set to all ones |
| 8 | SU- | 1 | Set to 1 when packet is a SU-beamformed packet |
| | Beamformed | | Set to 0 otherwise |
| | | | For MU: Reserved, set to 1 |
| 9 | Reserved | 1 | All ones |
| 10-17 | CRC | 8 | CRC calculated as in 11n Section 20.3.9.4.4 with C7 in |
| | | | B10 |
| 18-23 | Tail | 6 | All zeros |
| | Total | 24 | |

With respect to the Group ID field, the group membership to Multi-User MIMO (multiple-input-multiple-output) group refers to a group containing a plurality of recipients and each recipient receives transmissions as addressed to it, e.g. a MU-MIMO PPDU contains multiple individually addressed PPDUs. With respect to the Nₛₜₛ field, a MU-MIMO transmission contains multiple PPDUs that are transmitted in separate spatial streams. Each stream may use an independent modulation and coding scheme. Some of the bits of the Nₛₜₛ field are used contain spatial stream allocations for recipient STAs. On the other hand a single-user (SU) MIMO transmission refers to a PPDU that contains a single PPDU addressed to a single receiver or to a group address.

In an embodiment, the Group ID field may be used to identify whether the frame is transmitted as a single-user transmission addressed to a unique address of a recipient apparatus or as a multicast transmission addressed to a group address, wherein the group address is a common address from which it is received by a plurality of wireless communication apparatuses. Depending on the value of the Group ID field, the Nₛₜₛ field may be used to identify the subset of group-addressed frames as specified in embodiments described next. Tables 2 and 3 below are related to embodiments for identifying the subset of group-addressed frame by an information element comprised in the PLCP header. The embodiments provide information elements that enable the receiver to determine between at least the following subsets of group-addressed frames: a data frame addressed to a group address belonging to a given group-addressed stream and a data or management frame addressed to a group address not belonging to any group-addressed stream. The group-addressed stream may comprise a flexible multicast stream (FMS) specified in the IEEE 802.11v, wherein the FMS stream may be identified in the PLCP header by a stream identifier (FMSID) that serves as the group address, as described below. In IEEE 802.11v, the FMS enables devices to setup special delivery groups for group-addressed frames and to specify delivery times for the group-addressed frames of the FMS. A given STA may request participation in a designated FMS, and the AP may grant the participation, thereby configuring the STAs to receive group-addressed FMS frames. In such embodiments, one subset of group-addressed frames may be a frame that belongs to an FMS, wherein the group-addressing is realized by the FMSID. The delivery rules may be proposed to the AP by non-AP STAs, and the AP may decide the delivery rules that should be applied to the frames. It should, however, be appreciated that embodiments described herein are applicable to other group-addressed streams as well. Some embodiments define further subsets for the above-mentioned subset where the frame is addressed to a group address not belonging to any group-addressed stream. Is such embodiments, a further subset may be defined as a management frame addressed to a group address, while another subset may be defined as a data frame addressed to a group address but not part of any group-addressed stream.

TABLE 2

| | | | N_{STS} bit | |
|---|---|---|---|---|
| GroupID bits 4-9 | N_{STS} bits 10-12 | N_{STS} bits 13-20 | 21 | Reserved values of Nₛₜₛ field |
| Value [1, 1, 1, 1, 1, 1] | Space time | Contains Association | | Value [0, 0, 0, 0, 0, 0, 0, 0, 0] in Nsts |
| indicates | stream | identifier (AID) | | bits 13-21 is reserved. Other |
| individually | allocations | of the frame | | values provide the AID of the |
| addressed frame | | | | recipient |
| Value [1, 1, 1, 1, 1, 0] | Space time | Contains FMSID | Ack | Value [0, 0, 0, 0, 0, 0, 0, 0] Nsts bits |
| indicates group | stream | of the frame | follows | 13-21 indicates MMPDU |
| addressed frame | allocations | | | transmitted to group address, |
| | | | | Value [0, 0, 0, 0, 0, 0, 0, 1] in |
| | | | | FMSID field indicates MSDU |
| | | | | transmitted to group address |
| | | | | that is not mapped to any |
| | | | | FMSID. Other values in |
| | | | | FMSID field indicate the FMSID |
| | | | | of the frame. |

Referring to Table 2, the GroupID field of the PLCP header may be used to indicate whether the frame is addressed to a single receiver (e.g. value of all ones) or to a group address (e.g. value 1 1 1 1 1 0). For the frame addressed to the single recipient, the Nₛₜₛ field may define the space-time stream allocations and an identifier of the recipient, e.g. an Association Identifier. When the frame is addressed to a group address, the GroupID bits 4 to 9 may be set to have another value, e.g. 1 1 1 1 1 0, to identify that the frame belongs to one of the subsets of group-addressed frames. The group-addressed frames may comprise SU-MIMO transmissions addressed to a group address. When the frame is defined as the group-addressed frame in the GroupID field, three bits of the Nₛₜₛ field may be used for indicating the space-time stream allocation, and the remaining bits may be used to identify the subset. For example, a value of all zeros in bit indices 13 to 21 of the Nₛₜₛ field may be used to define that the frame is a management or frame addressed to a group address. Another value in bit indices 13 to 21 of the Nₛₜₛ field, e.g. 0 0 0 0 0 0 0 1, may be used to define that the frame is a data frame but not part of any FMS. In such a case, the identifier of the recipient may be provided in other fields, e.g. in the MAC header. The remaining in bit indices 13 to 21 of the Nₛₜₛ field may be used to define that the frame is a data frame part of a FMS, and the FMS is identified by the value of the bit indices 13 to 21 (FMSID). The FMSID is considered as the group address for the FMS.

As a consequence, the receiver of the frame may analyze the Group ID and Nₛₜₛ fields of the PLCP header so as to determine the subset of group-addressed frames. For example, the receiver is able to determine the FMS to which the frame belongs and determine whether the receiver is configured to receive the FMS. If the receiver is not configured to receive any FMS or if the receiver is configured to receive a FMS but not that identified by the FMSID, the receiver may neglect receiving the frame to save power resources. The receiver is also able to determine whether the frame is a MAC management service data unit (MMSDU) that will be transmitted as MAC management payload data unit (MMPDU), addressed to a group address. If the receiver is configured to receive such management (or generally control) frames, the receiver may then proceed to process the frame or, otherwise, and discard the frame. In some embodiments, the receiver may also enter the power-save mode and shut down at least some of its transmission, reception, and/or processing circuitries.

Table 3 below relates to an embodiment where the subsets include a subset related to frames belonging to a FMS and a subset related to frames not belonging to any FMS.

TABLE 3

| | | | N_{STS} bit | |
|---|---|---|---|---|
| GroupID bits 4-9 | N_{STS} bits 10-12 | N_{STS} bits 13-20 | 21 | Reserved values of Nₛₜₛ field |
| Value [1, 1, 1, 1, 1, 1] | Space time | Contains Association | | Value [0, 0, 0, 0, 0, 0, 0, 0, 0] in Nsts |
| indicates either an | stream | identifier (AID) | | bits 13-21 indicates a group |
| individually | allocations | of the frame | | addressed frame not part of |
| addressed frame or | | | | any FMS. Other values provide |
| a non-FMS related | | | | the AID of the recipient |
| group-addressed | | | | |
| frame. | | | | |
| Value [1, 1, 1, 1, 1, 0] | Space time | Contains FMSID | Ack | Values in FMSID field indicate |
| indicates group | stream | of the frame | follows | the FMSID of the frame. |
| addressed frame | allocations | | | |

In this embodiment, the GroupID field of the PLCP header may be used to indicate whether the frame is an individually addressed frame or a non-FMS related group-addressed frame. (value of all ones) or a group-addressed frame (e.g. value 1 1 1 1 1 0). For the individually addressed frame or the non-FMS related group-addressed frame, the Nₛₜₛ field may define the space-time stream allocations and an identifier of the recipient, e.g. an Association Identifier, as in the previous identifier. However, in this embodiment value of all zeroes for bits 13 to 21 in the Nₛₜₛ field (when the GroupID has all ones) is used to define the group-addressed subset where the frame does not belong to any FMS. As a consequence, this subset is defined by the combination of Group ID having all ones and Nₛₜₛ having in all bit indices 13 to 21 zeroes. When the frame is addressed to a group address, the GroupID bits 4 to 9 may be set to have another value, e.g. 1 1 1 1 1 0, to identify that the frame belongs to another subset of group-addressed frames. This value of GroupID field may be used to define a subset where the frame belongs to an FMS, and the FMS may be identified by the FMSID in bit indices 13 to 20. As a consequence, the receiver may in such embodiments determine from the value of the GroupID field whether or not the frame belongs to a group-addressed delivery group that is identified by specific FMSID. A group addressed delivery group is set up by the request of a given STA, and AP organizes the delivery groups. If the device is for some reason not provided with information on delivery groups to which it belongs, it is safe for the device to receive group-addressed frames from all delivery groups. In this way, the device will receive all transmitted group-addressed traffic. The device will request the available FMSIDs from the AP and gain knowledge how the group addressed frames are transmitted. Thus, the device may avoid receiving the group addressed frames from the FMSID which it is not intended to receive. This helps to reduce the power consumption of the device.

If the frame does not belong to the subset of group-addressed FMSIDs (GroupID field has all ones), the receiver may be configured to analyze the Nₛₜₛ field so as to determine whether the frame belongs to a subset of group-addressed frames not belonging to any FMSID (Nₛₜₛ bits 13 to 21 are all zeroes) or whether the frame is addressed to a single receiver (other values in bits 13 to 21 of the Nₛₜₛ field). In case of any subset of group-addressed frames, the receiver may check whether the receiver is configured to receive the corresponding subset and the frame and, if not, it may enter the power-save mode.

As shown in Tables 2 and 3, some embodiments of the transmitting wireless communication apparatus include in the PLCP additional subsets for the subset of group-addressed FMS frames. The additional subsets comprise a subset where the group-addressed FMS frame is allocated to be followed by an acknowledgment message and a subset where the group-addressed FMS frame is allocated not to be followed by the acknowledgment message. As shown in Tables 2 and 3, a bit in Nₛₜₛ field and in bit index 21 indicates to which one of these subsets the frame belongs, when the GroupID field indicates a group-addressed frame and when the Nₛₜₛ otherwise indicates the FMS subset. As a consequence, the receiver may determine whether or not the FMS frame is scheduled to follow an acknowledgment period. For example, when the receiver is not configured to receive and process the FMS frame and when the FMS frame is followed by the acknowledgment period, the receiver may extend the power-save mode beyond the duration of the frame to cover also the following acknowledgment period. On the other hand, when the receiver is configured to receive and process the FMS frame, the receiving wireless communication apparatus recognizes that it is allocated to acknowledge the FMS frame and configures its transmitter to transmit the acknowledgment.

It should be noted that the embodiments described above in connection with Tables 2 and 3 are examples of carrying out the indication of the subset(s). It should be noted that other bits (or even other fields) may be used to carry the information of the subset in the PLCP header. For example, the acknowledgment bit may be contained in a bit index that precedes the bits used for defining the FMS.

FIG. 5 illustrates a structure of a frame according to an embodiment of the invention where the acknowledgment period follows the frame. The frame may be related to an enhancement of IEEE 802.11 called More Reliable Groupcast (MRG) which enables block acknowledgments in connection with group-addressed frames. However, embodiments of the invention are not limited to the MRG. As shown in FIG. 5, the frame is transmitted on a primary channel and on three auxiliary channels (secondary to quaternary), but it should be understood that the frame may be transmitted on any number of channels. The PLCP header is at the beginning of the frame, and it is transmitted as a plurality of copies, one PLCP header on each channel. Therefore, a wireless communication apparatus scanning for any one of the channels is able to receive and process the PLCP header to derive whether the frame belongs to any subset of group-addressed frames. Accordingly, the wireless communication apparatus is able to determine whether or not it should process a payload portion of the frame. In this example, the frame may belong to a subset of group-addressed frames where the acknowledgment period follows the frame and, accordingly, an acknowledgment message (ACK) follows the frame. Upon detection on the basis of processing the PLCP header that the wireless communication apparatus is not configured to process the frame and that the frame is followed by the acknowledgment period, the wireless communication apparatus enters a power-save mode for the duration of the frame and the following acknowledgment period. As mentioned above, the power-save mode may comprise discarding or preventing further processing or extraction of the frame. In some embodiments, the power-save mode comprises entering a stand-by mode in which case the wireless communication apparatus shuts down at least some of the reception and/or transmission circuitries. The wireless communication apparatus may be configured not to attempt channel access on the channel in which the PLCP header(s) was/were received for the duration of the frame and the acknowledgment period. Therefore, the PLCP header may define a subset of group-addressed frames that extends the channel protection beyond the duration of the frame, wherein the channel protection is extended to cover also the following acknowledgment message.

FIG. 6 illustrates concatenation of acknowledgment messages for a group-addressed frame. As described previously, the PLCP header may indicate a subset where one or more acknowledgment periods follow the frame. Accordingly, wireless communication apparatuses processing the PLCP header and determining not to process the payload portion of the frame suspends the channel access for the duration of the frame and the following acknowledgment period(s), as shown in FIG. 6. The group addressed frame may contain block acknowledgment request (BAR) frame for the group addressed frame(s) and the BAR frame specifies the devices that will acknowledge the transmitted group addressed frames. Accordingly, the wireless communication apparatus detecting the allocation of the one or more acknowledgments after the group-addressed frame is configured to extend the suspension of the channel access to cover the following acknowledgment period(s) as well. In this manner, an arbitrary number of acknowledgment periods may be configured by using the PLCP header of the group-addressed frame, and the channel protection may be extended accordingly. The wireless communication apparatuses processing the frame and configured to carry out the acknowledgment may then gain the channel access after the frame to transmit the acknowledgment message.

In summary, embodiments of the present invention configure the transmitting wireless communication apparatus to include in the PLCP header at least one information element that defines a subset of group-addressed frames for a frame. Correspondingly the receiving wireless communication apparatus is configured to determine from the PLCP header of the received frame whether or not the frame is a group-addressed frame and, if it is, the subset of group-addressed frames for the received frame. On the basis of that determination, the receiving wireless communication apparatus determines whether or not it is configured to process the corresponding subset and, if not, it enters a power-save mode and omits the processing of the payload portion of the frame. Embodiments of the present invention define at least some of the following subsets of group-addressed frames in the PLCP header:
a data frame of a data stream assigned with a stream identifier used as a group address. The following subsets for this subset may include:
   The data frame is followed by an acknowledgment period
   The data frame is not followed by an acknowledgment period
a group-addressed frame not belonging to any data stream. The following subsets for this subset may include:
   A group-addressed management frame
   a group-addressed data frame
      The data frames may be encrypted so that their payloads cannot be processed unless the wireless communication apparatus is provided with appropriate decryption keys. On the other hand, management frames may be unencrypted messages. Thus, embodiments of the present invention enable the wireless communication apparatus to determine from the PLCP header whether or not the extraction of the payload portion should be omitted, and processing and power resources may be saved, when the PLCP header indicates that the payload portion should not be extracted by the wireless communication apparatus.

It should be understood that the invention is not bound to the PLCP header and the VHT signal fields of the IEEE 802.11ac. In general, the wireless communication apparatus according to an embodiment of the invention may determine from another header, whether it should process the payload portion of the frame or to enter the power-save mode. The header may be received on a channel that is a primary channel or an auxiliary channel of the transmitter of the frame, and the header may be copied to every channel (primary and every auxiliary channel) of the data transmission so as to enable its detection on each channel separately.

A beacon frame indicates the presence of the BSSs in the neighborhood. The devices that are scanning for the other BSSs in the coverage area may also perform background scanning, e.g. by listening to transmission media and trying to receive transmitted beacon frame correctly, or they may perform active scanning and send probe.request and receive probe.response messages. The beacon frames and other MAC management PDUs may be detectable from the GroupId and Nsts values. For instance, when the device is not associated to any BSS, it may receive only the frames which GroupID and Nsts indicates the transmission of a group-addressed management frame (MMPDU). Typically, group addressed MMPDUs are probe response frames transmitted to a group address, or beacon frames transmitted to a group address. Enabling the device to determine such a management frame from the PLCP header and filtering all other traffic reduces the power consumption in the network scanning particularly if the scanned channel contains numerous transmissions.

Also the PLCP indication of MMPDU transmitted to group address may provide indication that a BSS is available at a specific channel. The reception of the PLCP indication may be possible with lower transmission power and the recipient is able to maintain synchronization to an AP even when the beacon frame cannot be received. This may be important at indoor locations, where the transmission strength may change rapidly.

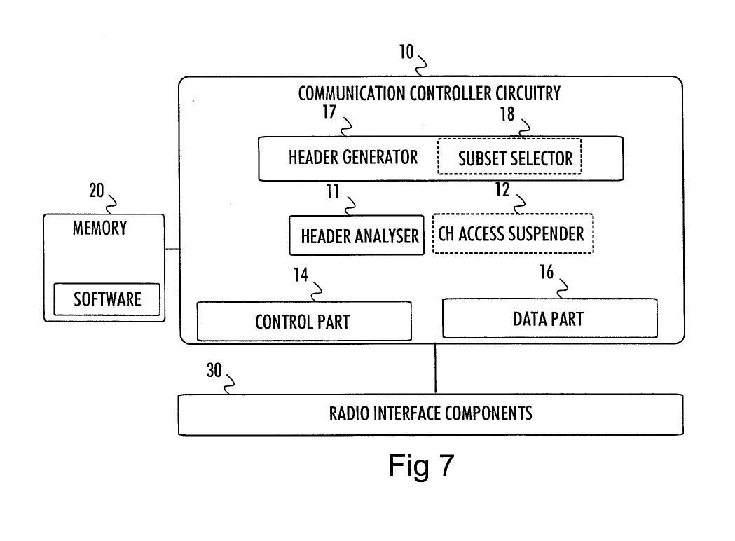

FIG. 7 illustrates an embodiment of an apparatus comprising means for carrying out the above-described functionalities of the receiving wireless communication apparatus that determines whether or not to process the payload portion of the frame. The apparatus may be a wireless communication apparatus of an IEEE 802.11 network or another wireless network, e.g. an AP or STA. The wireless communication apparatus may be a computer (PC), a laptop, a cellular phone, a palm computer, a fixed base station operating as the AP, or any other wireless communication apparatus. In another embodiment, the apparatus comprises a circuitry, e.g. a chip, a chipset, a processor, a micro controller, or a combination of such circuitries that may be installed to the wireless communication apparatus.

The apparatus may comprise a communication controller circuitry 10 configured to control the communications in the wireless communication apparatus. The communication controller circuitry 10 may comprise a control part 14 handling control signaling communication with respect to transmission, reception, and extraction of management frames and assembling and extracting control headers associated with data transmissions. The communication controller circuitry 10 may further comprise a data part 16 that handles transmission and reception of payload data. The control part 14 may also be configured to tune the wireless communication apparatus to monitor and receive signals on at least those channels that are used by a BSS of the wireless communication apparatus as communication channels. The channels being monitored may comprise communication channels of another BSS as well, as described above. As a consequence, the control part 14 may be configured to monitor and receive control messages and decode and extract information contained in the received control messages.

The communication controller circuitry 10 may further comprise a header analyzer circuitry 11 configured to extract header information contained in received headers, e.g. the PLCP headers. The extracted header information may comprise at least one determined field of the header, e.g. a field that enables the determination whether or not a frame associated with the header information is addressed to a single recipient or to a group address and, in case of the group-addressing, a subset of group-addressed frames of the frame. Such a field may comprise the group ID field and/or the N_{STS}, as described above. On the basis of the received header information, the header analyzer circuitry 11 may carry out step 304 of FIG. 3 so as to determine the subset and whether or not to process the payload of the frame. When the header analyzer circuitry 11 determines not to process the payload portion, it may further determine whether or not the acknowledgment period follows the frame. If so, the header analyzer circuitry 11 may provide a corresponding signal to a channel suspender circuitry 12 configured to control channel access of the wireless communication apparatus. Upon reception of the signal indicating that the frame comprising the header analyzed by the header analyzer circuitry 11 is not expected to be followed by another transmission, the channel access suspender circuitry 12 controls the data part 16 and the control part 14 to suspend transmission at least on the channel(s) on which the header was received for the duration of the frame. Reception and channel monitoring on those channels may be maintained, or the reception may also be suspended in order to save power. Upon reception of the signal indicating that the data transmission comprising the header analyzed by the header analyzer circuitry 11 is expected to be followed by another transmission, the channel access suspender circuitry 12 controls the data part 16 and the control part 14 to suspend transmission at least on the channel(s) on which the header was received for a duration that is longer than the duration of the data transmission, as described above.

With respect to transmission, the communication controller circuitry 10 may comprise a header generator circuitry 17 configured to generate a header for frames transmitted from the wireless communication apparatus. With respect to the PLCP header, the header generator circuitry 17 may comprise a subset selector circuitry 18. The header generator 17 may first determine whether a frame to be transmitted is addressed to a single recipient or to a group address. If the frame is a group-addressed frame, the subset selector circuitry 18 may select an appropriate subset of the frame and insert in appropriate fields of the header information elements having values that designate the subset, e.g. GroupId and/or Nₛₜₛ fields described above. When the PLCP header is finished, the header generator circuitry may output the header to the control part 14 or the data part 16 in order to apply the header to the payload portion of the frame and to transmit the frame.

The circuitries 11 to 18 of the communication controller circuitry 10 may be carried out by the one or more physical circuitries or processors. In practice, the different circuitries may be realized by different computer program modules. Depending on the specifications and the design of the apparatus, the apparatus may comprise some of the circuitries 11 to 18 or all of them.

The apparatus may further comprise a memory 20 that stores computer programs (software) configuring the apparatus to perform the above-described functionalities of the wireless communication apparatus. The memory 20 may also store communication parameters and other information needed for the wireless communications, e.g. the different subsets of group-addressed frames and default values for the duration of suspension in each case. The apparatus may further comprise radio interface components 30 providing the apparatus with radio communication capabilities within the BSS and with other BSSs. The radio interface components 30 may comprise standard well-known components such as amplifier, filter, frequency-converter, (de)modulator, and encoder/decoder circuitries and one or more antennas. The apparatus may further comprise a user interface enabling interaction with the user of the communication device. The user interface may comprise a display, a keypad or a keyboard, a loudspeaker, etc.

In an embodiment, the apparatus carrying out the embodiments of the invention in the communication apparatus comprises at least one processor and at least one memory including a computer program code, wherein the at least one memory and the computer program code are configured, with the at least one processor, to cause the apparatus to carry out the embodiments of the process of FIG. 2 and/or FIG. 3. As a consequence, the transmitting and reception properties according to embodiments of the invention may both be implemented in the same apparatus such that the apparatus is configured to include in the PLCP header of a transmitted frame information on the subset of a group-addressed frame and to determine the subset from received PLCP headers. In further embodiments, the at least one memory and the computer program code are configured, with the at least one processor, to cause the apparatus to carry out any one of the embodiments related to processing the received PLCP headers in order to determine the subset according to embodiments of the invention, as described above in connection with FIGS. 3 to 6. Accordingly, the at least one processor, the memory, and the computer program code form processing means for carrying out embodiments of the present invention in the wireless communication apparatus.

As used in this application, the term ‘circuitry’ refers to all of the following: (a) hardware-only circuit implementations, such as implementations in only analog and/or digital circuitry, and (b) to combinations of circuits and software (and/or firmware), such as (as applicable): (i) a combination of processor(s) or (ii) portions of processor(s)/software including digital signal processor(s), software, and a memory or memories that work together to cause the apparatus to perform various functions, and (c) to circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term “circuitry” would also cover an implementation of merely a processor (or multiple processors) or a portion of a processor and its (or their) accompanying software and/or firmware. The term “circuitry” would also cover, for example and if applicable to the particular element, a baseband integrated circuit or applications processor integrated circuit for a mobile phone or a similar integrated circuit in server, a cellular network device, or other network device.

The processes or methods described in connection with FIGS. 2 to 6 may also be carried out in the form of one or more computer processes defined by one or more computer programs. The computer program(s) may be in source code form, object code form, or in some intermediate form, and it may be stored in some sort of carrier, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital processing unit or it may be distributed amongst a number of processing units. As the present invention relates to frame headers, some embodiments of the invention provide a communication signal comprising the above-described PLCP header.

The present invention is applicable to wireless telecommunication systems defined above but also to other suitable telecommunication systems. The protocols used, the specifications of the wireless telecommunication systems, their network elements and subscriber terminals, develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. The invention and its embodiments are not limited to the examples described above but may vary within the scope of the claims.

1. A method, comprising:
receiving, in a wireless communication apparatus, a physical layer convergence protocol header of a frame;
determining from header information comprised in the physical layer convergence protocol header a subset of group-addressed frames to which the frame belongs;
determining whether or not the wireless communication apparatus is configured to process the determined subset of the frame; and
upon determining that the wireless communication apparatus is not configured to process the subset of the frame, causing the wireless communication apparatus to enter a power-save mode.

2. The method of claim 1, wherein one subset indicated by the header information comprised in the physical layer convergence protocol header defines that the frame is a data frame addressed to a plurality of recipients, wherein the physical layer convergence protocol header comprises an identifier defining a group of recipients for the frame, wherein the identifier is at least one of a group address and a multicast stream identifier, the method further comprising:
determining that the received frame belongs to the subset of the data frame addressed to a plurality of recipients;
determining whether or not the wireless communication apparatus is configured to process the subset; and
upon determining that the wireless communication apparatus is not configured to process the subset, causing the wireless communication apparatus to enter the power-save mode and, otherwise, configuring the wireless communication apparatus to process a payload portion of the frame.

3. The method of claim 1, wherein the header information comprised in the physical layer convergence protocol header comprises a group identifier field as an information element, wherein the group identifier defines whether the frame is addressed to a single recipient or to a group address, and wherein the header information further comprises another field that defines a subset of group-addressed frames when the group identifier field defines the frame being addressed to the group address, and the other field has another function when the group identifier field defines the frame being addressed to the single recipient.

4. The method of claim 1, wherein the header information comprised in the physical layer convergence protocol header comprises an information element defining a maximum number of spatial streams in a single-user transmission, a recipient address when the frame is addressed to a single recipient, and the subset of group-addressed frames when the frame is addressed to a group address.

5. The method of claim 1, wherein the header information comprised in the physical layer convergence protocol header comprises an information element indicating, as subsets of group-addressed frames, whether or not an acknowledgment message is allocated to be transmitted after the frame, the method further comprising determining, from the information element indicating whether or not the acknowledgment message is allocated to be transmitted after the frame, whether or not to a determined time interval after the frame is reserved for the acknowledgment message.

6. The method of claim 1, wherein one subset indicated by the header information comprised in the physical layer convergence protocol header defines that the frame is a management frame addressed to a plurality of recipients, wherein the physical layer convergence protocol header comprises an identifier defining a group of recipients for the frame, the method further comprising:
determining that the wireless communication apparatus is configured to process only management frames;
determining from the header information comprised in the physical layer convergence protocol header whether or not the frame is a management frame; and
discarding the frame, if the frame is not determined to be the management frame, while processing the frame, if the frame is determined to be the management frame.

7. A method, comprising:
initiating, in a wireless communication apparatus, transmission of a frame;
generating a physical layer convergence protocol header for the frame, wherein the physical layer convergence protocol header is arranged to comprise information identifying a subset of group-addressed frames to which the frame belongs; and
causing the wireless communication apparatus to transmit the frame comprising the physical layer convergence protocol header.

8. The method of claim 7, further comprising including in the physical layer convergence protocol header an information element that defines a subset of the frame being a management frame addressed to a group address.

9. The method of claim 7, further comprising including in the physical layer convergence protocol header an information element that defines a subset of the frame being a group-addressed data frame that does not belong to any flexible multicast stream assigned with a flexible multicast stream identifier.

10. The method of claim 7, further comprising including in a group identifier field of the physical layer convergence protocol header an information element having a first value for defining that the frame is addressed to a single recipient and a second value for defining that the frame is addressed to a group address, and wherein the header information further comprises another field that defines a subset of group-addressed frames when the group identifier field defines the frame being addressed to the group address, and the other field has another function when the group identifier field defines the frame being addressed to the single recipient.

11. An apparatus comprising:
at least one processor; and
at least one memory comprising a computer program code, wherein the at least one memory and the computer program code are configured, with the at least one processor, to cause the apparatus to:
receive a physical layer convergence protocol header of a frame;
determine from header information comprised in the physical layer convergence protocol header a subset of group-addressed frames to which the frame belongs;
determine whether or not the apparatus is configured to process the determined subset of the frame; and
upon determining that the apparatus is not configured to process the subset of the frame, causing the apparatus to enter a power-save mode.

12. The apparatus of claim 11, wherein one subset indicated by the header information comprised in the physical layer convergence protocol header defines that the frame is a data frame addressed to a plurality of recipients, wherein the physical layer convergence protocol header comprises an identifier defining a group of recipients for the frame, wherein the identifier is at least one of a group address and a multicast stream identifier, and wherein the at least one memory and the computer program code are configured, with the at least one processor, to cause the apparatus to:
determine that the received frame belongs to the subset of the data frame addressed to a plurality of recipients;
determine whether or not the apparatus is configured to process the subset; and
upon determining that the apparatus is not configured to process the subset, causing the apparatus to enter the power-save mode and, otherwise, configuring the apparatus to process a payload portion of the frame.

13. The apparatus of claim 11, wherein the header information comprised in the physical layer convergence protocol header comprises a group identifier field as an information element, wherein the group identifier defines whether the frame is addressed to a single recipient or to a group address, wherein the header information further comprises another field that defines a subset of group-addressed frames when the group identifier field defines the frame being addressed to the group address, and the other field has another function when the group identifier field defines the frame being addressed to the single recipient.

14. The apparatus of claim 11, wherein the header information comprised in the physical layer convergence protocol header comprises an information element defining a maximum number of spatial streams in a single-user transmission, a recipient address when the frame is addressed to a single recipient, and the subset of group-addressed frames when the frame is addressed to a group address.

15. The apparatus of claim 11, wherein the header information comprised in the physical layer convergence protocol header comprises an information element indicating, as subsets of group-addressed frames, whether or not an acknowledgment message is allocated to be transmitted after the frame, and wherein the at least one memory and the computer program code are configured, with the at least one processor, to cause the apparatus to determine, from the information element indicating whether or not the acknowledgment message is allocated to be transmitted after the frame, whether or not to a determined time interval after the frame is reserved for the acknowledgment message.

16. The apparatus of claim 11, wherein one subset indicated by the header information comprised in the physical layer convergence protocol header defines that the frame is a management frame addressed to a plurality of recipients, wherein the physical layer convergence protocol header comprises an identifier defining a group of recipients for the frame, and wherein the at least one memory and the computer program code are configured, with the at least one processor, to cause the apparatus to:
determine that the apparatus is configured to process management frames;
determine from the header information comprised in the physical layer convergence protocol header whether or not the frame is a management frame; and
discard the frame, if the frame is not determined to be the management frame, while processing the frame, if the frame is determined to be the management frame.

17. An apparatus, comprising:
at least one processor; and
at least one memory comprising a computer program code, wherein the at least one memory and the computer program code are configured, with the at least one processor, to cause the apparatus to:
initiate transmission of a frame;
generate a physical layer convergence protocol header for the frame, wherein the physical layer convergence protocol header is arranged to comprise information identifying a subset of group-addressed frames to which the frame belongs; and
causing the apparatus to transmit the frame comprising the physical layer convergence protocol header.

18. The apparatus of claim 17, wherein the at least one memory and the computer program code are configured, with the at least one processor, to cause the apparatus to include in the physical layer convergence protocol header an information element that defines a subset of the frame being a management frame addressed to a group address.

19. The apparatus of claim 17, wherein the at least one memory and the computer program code are configured, with the at least one processor, to cause the apparatus to include in the physical layer convergence protocol header an information element that defines a subset of the frame being a group-addressed data frame that does not belong to any flexible multicast stream assigned with a flexible multicast stream identifier.

20. The apparatus of claim 17, wherein the at least one memory and the computer program code are configured, with the at least one processor, to cause the apparatus to include in a group identifier field of the physical layer convergence protocol header an information element having a first value for defining that the frame is addressed to a single recipient and a second value for defining that the frame is addressed to a group address, and wherein the header information further comprises another field that defines a subset of group-addressed frames when the group identifier field defines the frame being addressed to the group address, and the other field has another function when the group identifier field defines the frame being addressed to the single recipient.

21. The apparatus of claim 11, further comprising radio interface components providing the apparatus with radio communication capability in a wireless communication network.

22. (canceled)

23. A computer program product embodied on a distribution medium readable by a computer and comprising program instructions which, when loaded into an apparatus, execute a process comprising
receiving a physical layer convergence protocol header of a frame;
determining from header information comprised in the physical layer convergence protocol header a subset of group-addressed frames to which the frame belongs;
determining whether or not a wireless communication apparatus receiving the frame is configured to process the determined subset of the frame; and
upon determining that the wireless communication apparatus is not configured to process the subset of the frame, causing the wireless communication apparatus to enter a power-save mode.

24. The apparatus of claim 17, further comprising radio interface components providing the apparatus with radio communication capability in a wireless communication network.

25. A computer program product embodied on a distribution medium readable by a computer and comprising program instructions which, when loaded into an apparatus, execute a process comprising:
initiating transmission of a frame;
generating a physical layer convergence protocol header for the frame, wherein the physical layer convergence protocol header is arranged to comprise information identifying a subset of group-addressed frames to which the frame belongs; and
causing a wireless communication apparatus to transmit the frame comprising the physical layer convergence protocol header.
